(19) United States
(12) Patent Application Publication
(10) Pub. No.: US 2005/0232188 A1
(43) Pub. Date: Oct. 20, 2005

(54) QoS oriented handover method for mobile IPv6 in MPLS network

(76) Inventors: Kenichi Sakamoto, Kawasaki (JP); Shiro Tanabe, Hidaka (JP); Hui Deng, Beijing (CN); Hiroki Ikeda, Beijing (CN)

Correspondence Address: REED SMITH LLP, Suite 1400, 3110 Fairview Park Drive, Falls Church, VA, 22042, US

(21) Appl. No.: 11/059,488

(22) Filed: Feb. 17, 2005

(30) Foreign Application Priority Data
Mar. 31, 2004 (CN) 200410031957.9

(51) Int. Cl. H04Q 7/00

(52) U.S. Cl. 370/328

(57) ABSTRACT

The present invention provides a method building a handover system to improve the service quality in mobile networks. When a mobile node has received a plurality of care-of addresses, it will send a Prepare Multi-path (PM) message to a correspondent node. Once receiving the PM message, each router replaces the old input label in the PM message with a new input label, and then sends it to the next router. Each router adds a new item into the Split Path Table based on the received message. After sending the PM message, the mobile node sends a Request Multi-path (RM) message to a correspondent node. Each MPLS core router decides whether to stop the RM message or not when the RM message is received. If it is yes, the corresponding input label will be split and the generated data packet will be transmitted to two paths from this router. One is the path in the network where the mobile node has been located, another one is a new path in the visiting network.

### FIELD OF THE INVENTION

The present invention relates to communication technology in mobile networks, especially a handover method in mobile network communications.

### BACKGROUND OF THE INVENTION

Recently, there is a trend of that more and more suppliers of interconnection network service and administers of internet are considering switchover IP networks to MPLS (Multi-Protocol Label Switching) networks. Since traditional MPLS networks have no mobile functions, several schemes have been proposed to integrate mobile IP networks and MPLS ones, because the extensibility of data transfer in mobile IP networks can be improved by replacing IP-in-IP tunnels with MPLS. Integration of mobile IP and MPLS can also improve the validity and the service quality of the system in the accesses of wireless IP to networks. Label switching paths in corresponding MPLS networks can provide paths of reasonably high quality to different mobile IP services.

In the technology of integrating mobile IP and MPLS, Zhong Ren, et al (“Integration of Mobile IP and Multi-Protocol Label Switching”, ICC2001, June 2001) proposed a method to integrate the of mobile IP and MPLS protocols so as to replace IP-in-IP tunnels with MPLS.

Japanese patent (2003-60685) proposed that the problem of service quality in handover of mobile nodes is solved by using a mobile agent. A mobile agent will relay QoS reservation to external networks. After the communication between a correspondent node and a mobile node are performed directly, the relay of the mobile agent will be released.

In addition, Japanese patent (2004-15538) proposed that the access router in the local network can detect the switching and inform the request of flow QoS to the visiting access router before switching. And the visiting access router will inform these messages to the near LSR (core router, LSR: Label Switching Router). As the setting information of the LSP (Label Switching Path), the near LSR will establish new qualified band broadness for the mobile node in the MPLS network. After the renewing process has been finished, the new LSP will be released.

The above technical proposals defined how to support mobile IP services and the requests on MPLS networks, at the same time, the system and application approaches were described. The integration of MPLS networks and mobile IPv6 has many advantages. For example, a three-layer tunnel of mobile IPv6 can be reflected directly to a two-layer structure of MPLS networks, therefore the transfer speed of data packet can be increased. Traffic engineering of MPLS networks can be used to support high quality service in mobile nodes.

All the above proposals are based on an assumption that a boundary router LER must be a mobile node. But if all the routers must have mobile agent functions, not only the property of router will be sharply decreased, but also the performance of all integrated MPLS networks will be decreased.

Furthermore, for example, when a mobile node, i.e., a mobile terminal, moves from the home area to a visiting area, a new LSP must be established. This will inevitably waste label resources and, at the same time, the long LSP in the MPLS network will be overlapped, which will causes the multiple use of a lot of network resources and the increase of the number of labels in the MPLS network. These will decrease performance of the network. In addition, the multicast technique can be used to radio data. But if building a multicast, a multicast group must be built between a correspondent node and a mobile node. This will also waste a lot of network resources and decrease operation efficiency.

There are still no effective approaches to guarantee continuous and smooth terminal-to-terminal connection, at the same time, not waste resources of the network and increase the number of labels in MPLS network.

### SUMMARY OF THE INVENTION

In order to solve the above problems, a new path split method is proposed in the present invention. The split causes at the junction of an old path and a new one, which can significantly decrease the load of a router and the number of labels in a MPLS network, and prevent building new paths, at the same time, guarantee a smooth connection of mobile nodes during a handover.

The present method is realized by the path split protocol. In the path split protocol, a mobile node sends a PM message to a correspondent node after receiving a plurality of care-of addresses. The PM message informs the routers along the path to prepare the path split. Once receiving a PM message, each router replaces the old input labels in the PM message with new ones, and then, sends the PM message to the next router. Each router adds a new item into the SPT based on the received information. After the PM message is sent out, the mobile node sends a RM message to a correspondent node through its care-of address. In a MPLS network, the RM message will be written into CR-LDP (Constraint-Routing Label Distribution Protocol) and RSVP-TE (Resource Reservation Protocol) messages to be transmitted. CR-LDP and RSVP-TE protocols are means to reserve resources to guarantee service quality in MPLS networks. These protocols will be applied continuously in the present method to guarantee service quality during a handover of a mobile node. When a RM message is received, each MPLS core router LSR (Label Switching Router) will decide whether to stop the RM message at the router or not. If it is yes, the corresponding label will be split and a new output label will be written into the switching table. The generated data packet is transmitted to two paths from the router. One is the path in the network where the mobile node is located, another one is a new path in the visiting network.

The path split method of handover in a mobile network of the present invention is characterized in that: a signaling is sent to an access router to request a new path, and the path between a correspondent node and the mobile node is split when a mobile node performs a handover.

Another path split method of handover in MPLS mobile network of the present invention is characterized in that: a signaling is sent to an access router to request a new path and the path between a correspondent node and the mobile node is split when a mobile node performs a handover.

Said path split starts from the core router of a mobile network.

When a mobile node prepares to build a multi-path, it sends a Prepare Multi-path (PM) message to a correspondent node to inform the LSR routers along the path to prepare for path split, and once receiving the PM message, each LSR router checks the input label bits, if a CR-LDP protocol is used, the PM message will be written into a CR-LDP message, if a RSVP-TE protocol is used, the PM message will be written into a RSVP-TE message.

As receiving a PM message, each LSR router builds a Split Path Table (SPT) and adds an item into the table, in which all items are the same as the PM message.

After sending a PM message to a correspondent node, a mobile node sends a Request Multi-path (RM) message to a correspondent node by using the care-of address selected by itself.

Said LSR router which has built a SPT table checks whether the received CR-LDP message contains a RM message, if a RM message is contained, the LSR router will compare SPT table itself to the RM message, and then if they are completely same, the LSR router will decide to stop the CR-LDP message at the router, and conduct the path split based on the corresponding label information, and at the same time, add a path item into the MPLS transfer table.

Said LSR router which has built a SPT table checks whether the received RSVP-TE message contains a RM message, if a RM message is contained, the LSR router will compare SPT table itself to the RM message, and then if they are completely same, the LSR router will decide to stop the RSVP-TE message at the router, and conduct the path split based on the corresponding label information, and at the same time, add a path item into the MPLS transfer table.

The PM and RM messages contain band broadness information used in the band broadness control so as to guarantee the band broadness for real time communication when a mobile node performs a handover.

### BRIEF DESCRIPTION OF THE DRAWINGS

The object and advantages of the present invention will become clearer by referencing the attached drawings, in which the embodiment has been described in detail.

FIG. 1 is a network topological diagram of the handover of mobile IPv6 in MPLS network according to the present invention;

FIG. 2 is a signaling sequence diagram of prepare multi-path PM message based on CR-LDP in MPLS network according to the present invention;

FIG. 3 is a split path table according to the present invention;

FIG. 4 is a signaling sequence diagram of a RM message based on CR-LDP in MPLS network according to the present invention;

FIG. 5 is a signaling sequence diagram of a PM message based on RSVP-TE in MPLS network according to the present invention;

FIG. 6 is a signaling sequence diagram of a RM message based on RSVP-TE in MPLS network according to the present invention;

FIG. 7 is a system topological diagram of that the communication flow is split into two label switching paths LSP according to the present invention;

FIG. 8 is a flow chart of the protocol split algorithm according to the present invention;

FIG. 9 is a device system diagram of a LSR router according to the present invention;

FIG. 10 is a device system diagram of a LER router according to the present invention;

FIG. 11 is a device system diagram of a customer terminal according to the present invention; and

FIG. 12 is a data packet format of a detailed PM/RM message of the present invention.

### DETAILED DESCRIPTION OF THE PREFERRED EMBODIMENTS

A method building a handover system for reserving service quality in a mobile network is described in detail hereafter. This method will initialize a new path to a correspondent node automatically when a mobile node performs a handover in MPLS network. That is, the mobile node will select an access router or the most available router among a plurality of routers to establish the new path to the correspondent node when it decides to perform a handover. Certainly, the path split method of the present invention is not limited to the above MPLS network and mobile IPv6 network, it also can be applied to other networks. The above-mentioned mobile node and fixed node can be, for example, a communication terminal such as a mobile telephone or a notebook computer etc.

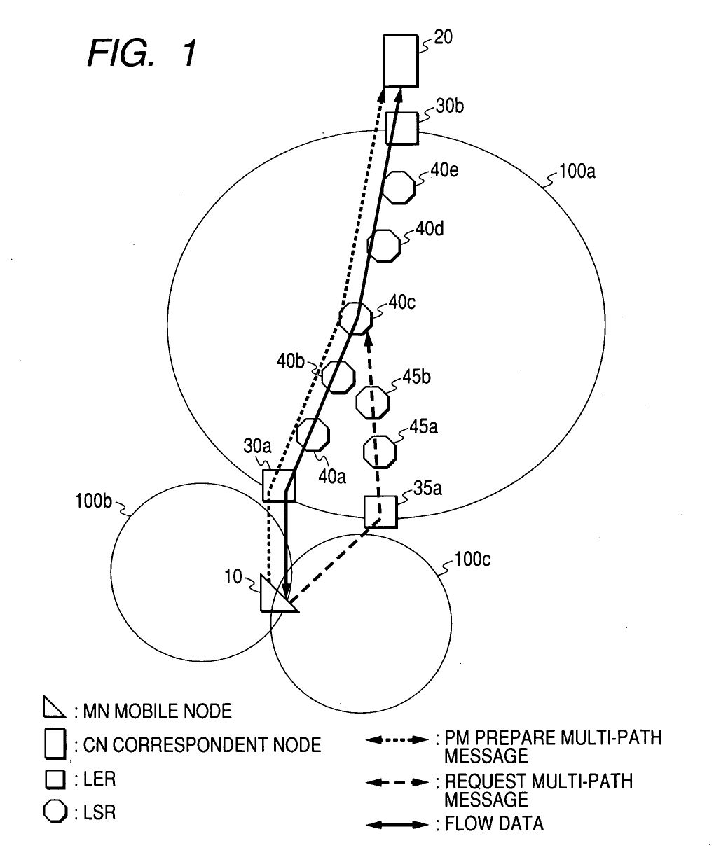

FIG. 1 is a network topological diagram of the handover of mobile IPv6 in MPLS network according to the present invention.

In FIG. 1, when mobile node 10 moves from home area 100b to visit area 100c, mobile node 10 will gets a care-of address in the cross area of the two areas, and will pass through two edge routers LERs 30a and 30b, and a plurality of core routers LSRs 40a, 40b, 40c, 40d and 40e, between the mobile node and the correspondent node.

The path split method of this invention enables core router LSR to split a plurality of output interfaces for mobile node 10 without running multicast forwarding technique. That is to say, mobile node 10 will prepare to establish a new path to correspondent node 20, after moving to the visit area 100c. As shown in FIG. 1, the new path includes two edge routers LERs 35a and 30b, and core routers LSRs 45a, 45b, 40c, 40d and 40e.

Specifically, when mobile node 10 prepares to establish multiple paths, it will send the prepare multi-path PM 501, 503, 505, 507, 509 messages to correspondent node 20 so as to inform core routers LSRs 30a, 40a, 40b, 40c, 40d, 40e and 30b along the path preparing path split.

In MPLS network according to the present invention, prepare multi-path messages can be based on different protocols such as CR-LDP and RSVP-TE etc., and each of protocols is described respectively hereafter.

IETF (Internet Engineering Task Force) allows many different label distribution protocols to exist. At the present time, IETF has set forward three label distribution protocols, that is:
1. Normal Label Distribution Protocol LDP

To establish, to disconnect, to protect, to reroute and to reestablish label switching path, the label distribution protocol LDP is a signaling protocol of MPLS. Even the expandability of the label distribution protocol and the degree of support to traffic engineering are decided directly on how to distribute labels and resource reservation through the label distribution protocol.
2. Constraint-Routing Label Distribution Protocol CR-LDP

CR-LDP adopts label request and label mapping, and all procedures are done by messages on the two functions.

CR-LDP uses the format of LDP, only with a partial supplement and adjustment relating to the traffic engineering. Constraint routing is mainly proceeded from two aspects: one is the characteristics of flow itself, the characteristic of traffic described by defining parameters such as, peak rate and burst traffic, guaranteed rate and burst traffic, extra burst size, frequency and weighting etc, and the other is the characteristic of network link resource, i.e. network resource itself. Network manager needs to classify the link into different classes of resource and “color” according to a certain rule so as to use it in the traffic engineering calculation.
3. Extended Resource Reservation Protocol (RSVP-TE)

RSVP-TE selects “Path” and “Resv” (reservation) as main messages, and all procedures are done mainly by the two messages.

On the basis of basic LDP, RSVP-TE has its peculiar advantage in protecting from network fault and blocking, at the same time, RSVP-TE simplifies running of the network by enabling the traffic engineering processing to be automatized.

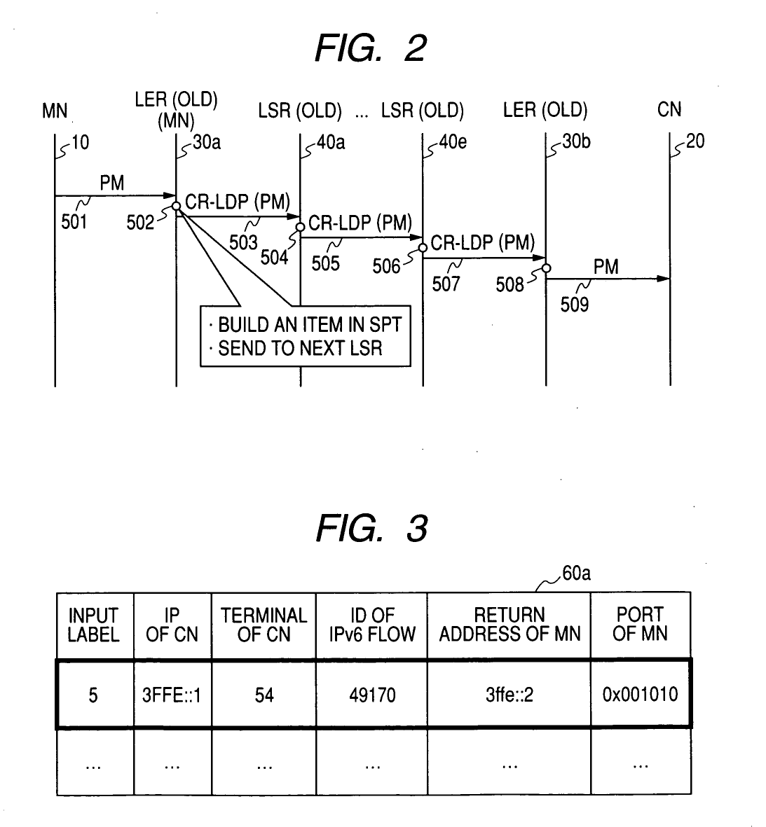

First, embedding PM message into CR-LDR message is described hereafter. FIG. 2 is a signaling sequence diagram to prepare multi-path PM message based on CR-LDP in MPLS network according to the present invention.

PM message includes the following information:
1) Input label of LSR
2) IP address of correspondent node 20
3) Port number of correspondent node 20
4) IPv6 flow ID
5) return address of mobile node 10
6) Port number of mobile node 10

Once receiving PM message, each of LSR 40a, 40b, 40c, 40d and 40e checks the input label contained in received PM 501, 503, 505, 507, 509 messages. Since the input label of PM message is also the output label of the upperstream router, the router can find out the corresponding output label from the corresponding MPLS switching table according to the input label. The router replaces old input label contained in PM message with a local input label, and then forwards it to the downstream routers LSR 503, 505, 507 and 509.

In the path split protocol, each of LSR 40a, 40b, 40c, 40d, 40e maintains a split path table 60a. FIG. 3 shows the split path table 60a according to the present invention. The core router LSR will establish a split path table every time when it has received a PM message, and add a line in the split path table as shown with a black frame in the Figure.

The split path table consists of the following components:
1) Input label of LSR
2) IP address of correspondent node 20
3) Port number of correspondent node 20
4) IPv6 flow ID
5) Return address of mobile node 10
6) Port number of mobile node 10

These items are completely the same as the contents of PM 501, 503, 505, 507, 509 messages, and the fact that the LSR contains PM message implies it is ready to split label switching path LSP.

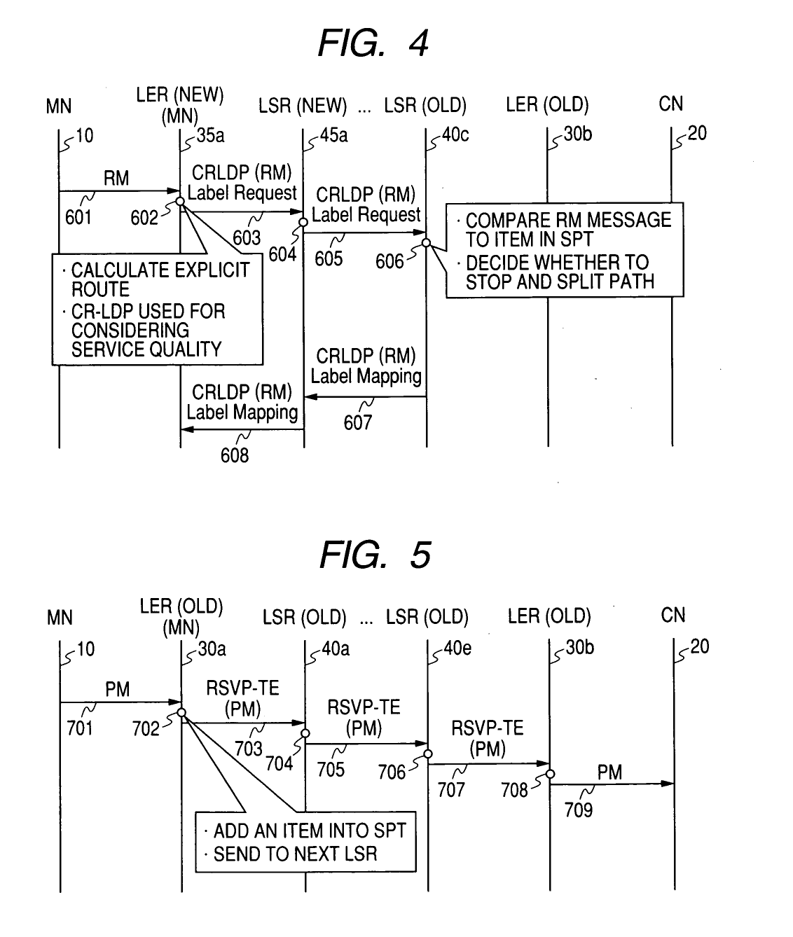

In this protocol, after sending PM 501, 503, 505, 507 and 509 messages to correspondent node 20, mobile node 10 also sends request multi-path messages RM 601, 603, 605 to correspondent node 20 using the care-of address selected by it self. Here, RM message has the same content as the PM message, and is also embedded in CR-LDP message. FIG. 4 is a signaling sequence diagram of a RM message based on CR-LDP in MPLS network according to the present invention

When the CR-LDP protocol has established a new path to correspondent node 20, the embedded RM messages will be sent to core routers LSRs 35a, 45a, 45b, 40c. First, the edge router LER will calculate an explicit route (ER) between the input LER 35a and the output LER 30b according to the initiated flow session and the requested service quality limit. Then, CR-LDP establishes part of label switching paths according to the distributed service quality resource, thus, RM messages have a triggering effect on the establishment of label switching paths.

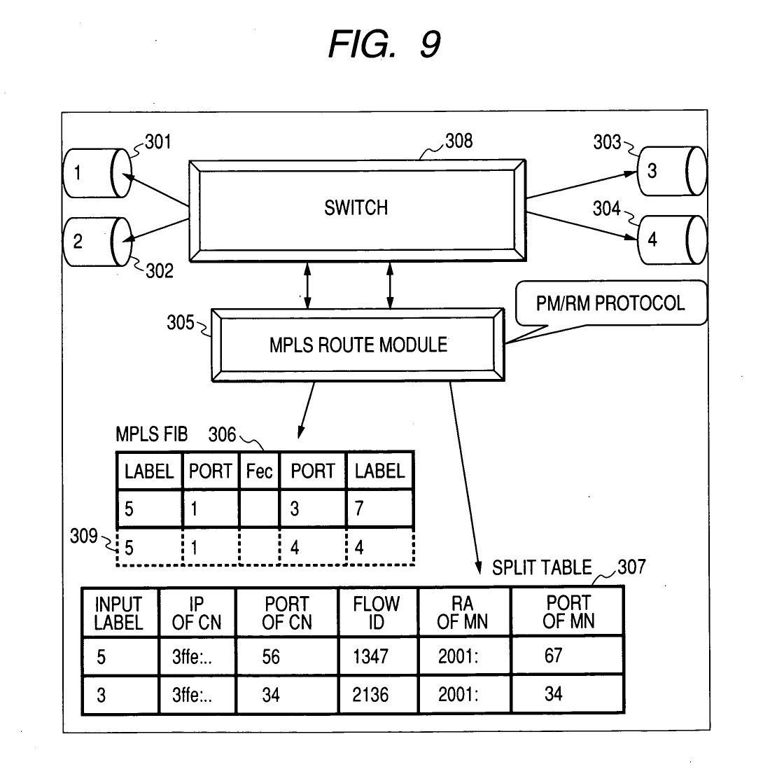

The routers LSR 35a, 45a and 45b which have not established split path table (SPT) will not read the RM messages embedded in CR-LDP data packets 602 and 604, while the router LSR 40c will read the RM message 606 contained in the received CR-LDP message because it has established SPT table. If CR-LDP data packets contain RM message, LSR will compare RM message 605 with SPT. If one of the messages contained in SPT 60a is completely the same as the content of RM message 605, the router LSR 40c will decide to stop transferring CR-LDP message 605 at the local, and make a split path according to the corresponding label message, and add the path item in the forwarding table 306 of MPLS at the same time. That is to say, the corresponding input label is duplicated so as to produce a new output label 309 and then write it in the switching table 306. As shown by 309 in FIG. 9, same as the above line, label of input part is 5, and port numbers is 1, while there are two different output, one having output label 3 and port number 7, and the other having output label 4 and port number 4. The new output label represents a new path, and the LSP label passes through 40c, 45b, 45a, 35a, and the destination is the new access router 35a of the mobile node.

Other access routers of the mobile node establish new path which has assurance of service quality according to the notice of the mobile node, and this new paths can be established by CR-LDP or RSVP-TE. Certainly, the new LSP label split path and the original LSP will have some common LSRs. That means they may have some common LSPs. In order to reduce the establishing time of LSP and avoid duplication of provided service quality, only part of LSP label split path is different and other same LSP will be shared in this method.

First, how to process multiple care-of address is described. Multiple care-of address can guarantee a smooth handover of mobile node, and it will be employed in this method.

Whether a mobile node can obtain multiple care-of addresses depends on the link layer technique in a plurality of embedded network. In this method, the mobile node can receive multiple care-of address. After receiving multiple care-of address, the mobile node will decide that which one is the network it may wants handover to by checking data packet loss ratio and data packet integrity. If the mobile node finds itself be in the course of handover, it should select a new access router and calculate its care-of addresses. However, if the decision is obtained only by checking data packet loss ratio and data packet integrity, sometimes may result in a misjudgment.

In the present invention, a radio channel synchronization method arranged between access routers and a mobile node is proposed, and the mobile node can know which is the router it will enter. The mobile node can set a rule by using the information of clock synchronization, so as to decide whether it is in course of a handover and which is the router it will enter.

An embodiment of embedding PM messages into RSVP-TE is explained hereafter.

FIG. 5 is a signaling sequence diagram of a PM message based on RSVP-TE in MPLS network according to the present invention.

The path split protocol enables core router LSR to split a plurality of output interfaces for mobile node 10 without running multicast forwarding technique when mobile node 10 prepares to establish multiple paths, it will send prepare multi-path PM 701, 703, 705, 707, 709 messages, to correspondent node 20 so as to inform core routers LSRs 30a, 40a, 40b, 40c, 40d, 40e and 30b along the path to prepare path split. The PM messages are embedded into RSVP-TE messages and transferred in MPLS area after reaching edge router. This conversion is implemented by edge router of the mobile node and edge router of the correspondent node.

PM message includes the following information:
1) Input label of LSR
2) IP address of correspondent node 20
3) Port number of correspondent node 20
4) IPv6 flow ID
5) Home address of mobile node 10
6) Port number of mobile node 10

After receiving PM message, each of LSR 40a, 40b, 40c, 40d and 40e checks the input label contained in received PM 701, 703, 705, 707, 709 messages. Since the input label of PM messages is also the output label of the upperstream LSR which sent the PM message, the router can find out the corresponding output label from the corresponding MPLS switching table according to the input label. The router replaces old input label contained in PM message with the local input label, and then forwards it to the downstream routers LSR 702, 704, 706 and 708.

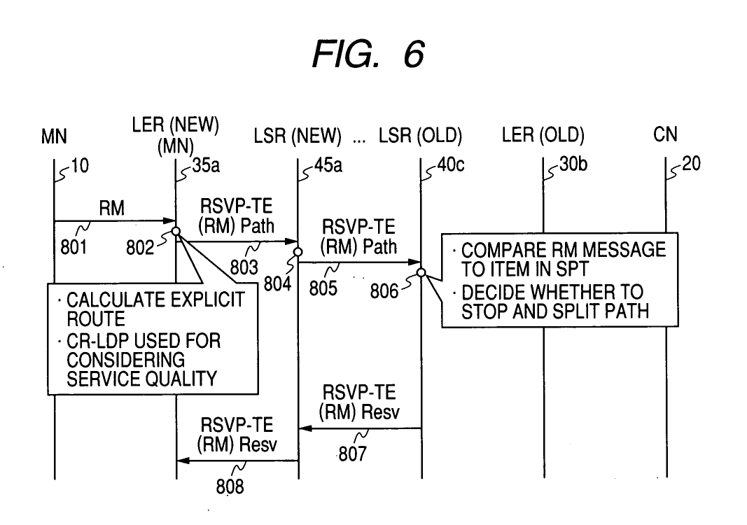

FIG. 6 is a signaling sequence diagram of a RM message based on RSVP-TE in MPLS network according to the present invention.

In this protocol, after sending PM 701, 703, 705, 707 and 709 messages to correspondent node CN, mobile node 10 also sends RM messages 801, 803, 805 to correspondent node 20 using the care-of address selected by itself. RM messages are embedded in RSVP-TE message. When the CR-LDP protocol has established a new path to correspondent node 20, the embedded RM messages will be sent to core routers LSRs 35a, 45a, 45b, 40c. First, the LER will calculate an explicit route (ER) between the input LER 35a and the output LER 30b according to the initiated flow session and the requested service quality limit. Then, RSVP-TE will establish part of label switching paths according to the distributed service quality resource.

The routers LSRs 35a, 45a and 45b which have not establish split path table (SPT) will not read the RM messages embedded in RSVP-TE data packets 802 and 804. The router LSR 40c which has established SPT will read the RM message 806 contained in received CR-LDP messages. If RSVP-TE data packet contains RM message, LSR will compare RM message 805 with SPT. If one of the messages contained in SPT is completely the same as the content of RM message 805, the router LSR 40c will decide to stop transferring RSVP-TE at the local, and the corresponding input label will be duplicated so as to produce a new output label and then write it in the switching table. The new output label represents part of the new label switching path LSP 40c, 45b, 45a, 35a, and the destination is CoA 100c.

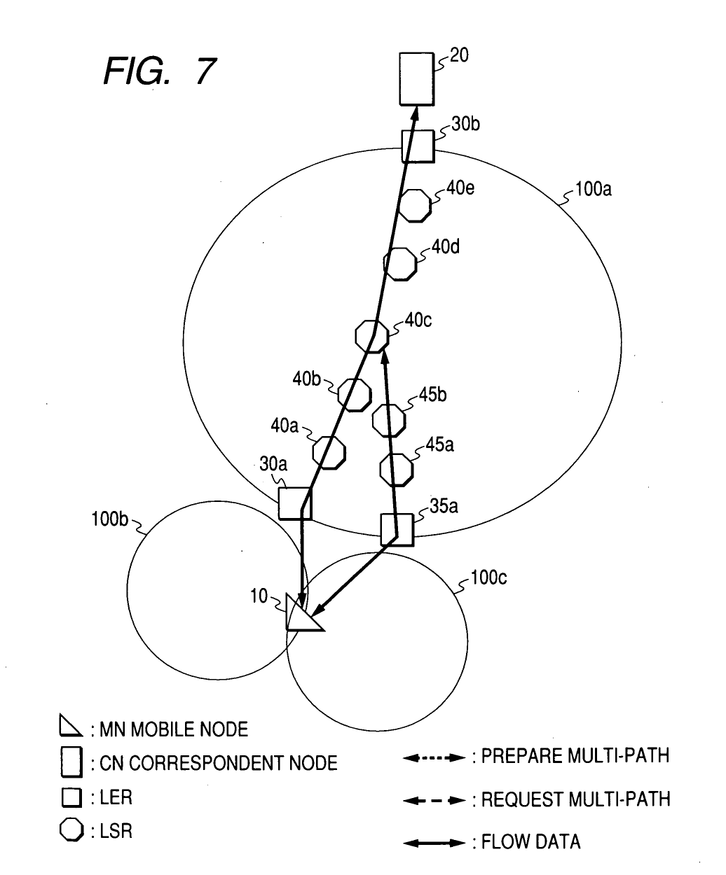

FIG. 7 is a system topological diagram of that the communication flow is split into two label switching paths LSP according to the present invention.

After the data packet has been duplicated in the core router, it will be sent to return address and the care-of address to which the mobile node wants handover along two label switching paths LSP 30b, 40e, 40d, 40c, 40b, 40a, 30a, and LSP 30b, 40e, 40d, 40c, 45b, 45a, 35a.

It is known from the figure that the two transferring paths of the data packet are overlapped at the section of routers 30b, 40e, 40d and 40c. Therefore, by comparison with the prior art which establish another totally new path, the path split method of this invention can save resources and reduce the load of devices.

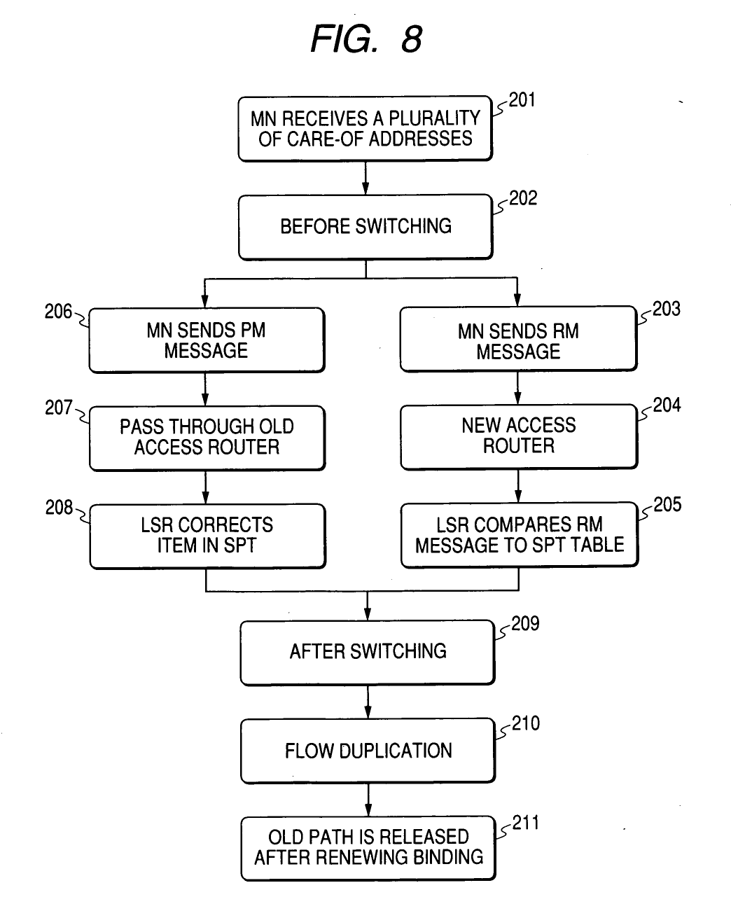

FIG. 8 is a flow chart of the protocol split algorithm according to the present invention.

When a mobile node starts a session between correspondent nodes requesting a high service quality, it will consider sending PM message to the correspondent node through an access router, and each router along this path will modify its SPT table based on this information. After the mobile node gets another care-of address, it will send RM message through a new access router, and each router which has received the RM message will compare the content of RM message with SPT table. If they are the same, the RM message will be stopped sending forward and start to duplicate the flow transfer. After establishing a new renewal, the previous flow can be released.

FIG. 9 is a device system diagram of LSR router according to the present invention. In the interior of LSR router, MPLS route module 305 can support RM/PM protocol, and the path split table 307 is also used to support RM/PM protocol except for MPLS FIB306 table.

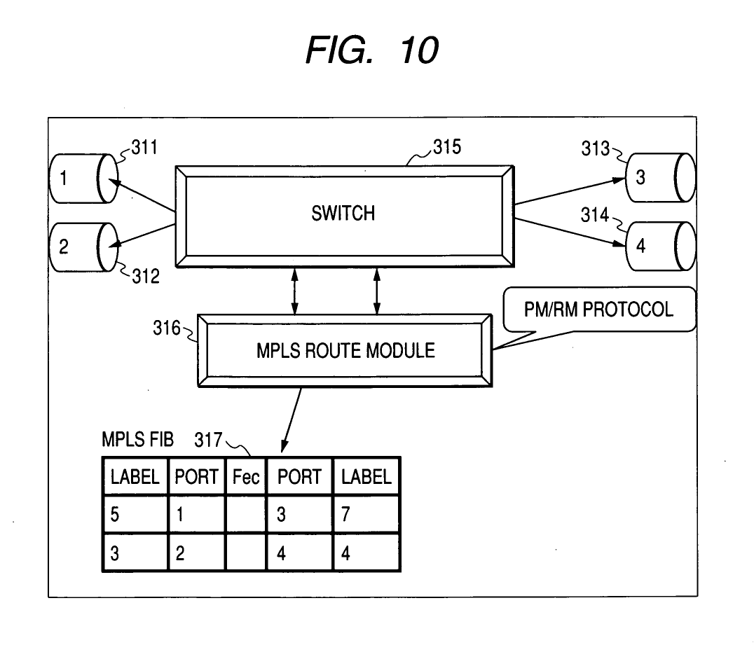

FIG. 10 is a device system diagram of LER router according to the present invention. LER router merely supports RM/PM message, and it is unnecessary for LER to establish the path split table.

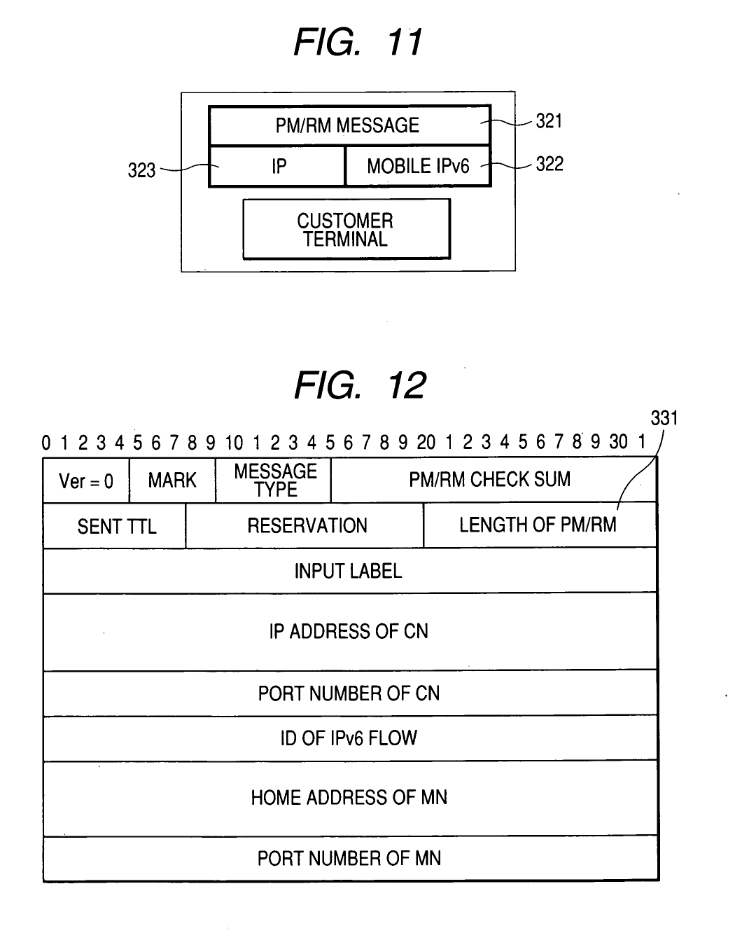

FIG. 11 is a device system diagram of customer terminal according to the present invention. Customer terminals are not in need of much modification, it is enough to support RM/PM messages wherein the service quality parameters will be considered.

FIG. 12 is a data packet format of a detailed PM/RM message of the present invention.

There are six parameters in total, including input label, IP address of correspondent node, port number of correspondent node, flow ID, return address of mobile node and port number of mobile node.

In this method, it is not necessary for each LER router to be a return agent or a mobility anchor point MAP in the layered mobile IPv6, this will remarkably reduce the load of routers, thereby, improving the performance of routers.

1. A path split method of handover in a mobile network, wherein a signaling is sent to an access router to request a new path and the path between a correspondent node and the mobile node is split when a mobile node performs a handover.

2. A path split method of handover in a MPLS network, wherein a signaling is sent to an access router to request a new path and the path between a correspondent node and the mobile node is split when a mobile node performs a handover.

3. A path split method according to claim 1, wherein said path split starts from the core router of a mobile network.

4. A path split method according to claim 2, wherein when a mobile node prepares to build a multi-path, it sends a Prepare Multi-path (PM) message to a correspondent node to inform the LSR routers along the path to prepare for path split, and once receiving the PM message, each LSR router checks the input label bits, if a CR-LDP protocol is used, the PM message will be written into a CR-LDP message, if a RSVP-TE protocol is used, the PM message will be written into a RSVP-TE message.

5. A path split method according to claim 1, wherein as receiving a PM message, each LSR router builds a Split Path Table (SPT) and adds an item into the table, in which all items are the same as the PM message.

6. A path split method according to claim 2, wherein after sending a PM message to a correspondent node, a mobile node sends a Request Multi-path (RM) message to the correspondent node by using the care-of address selected by itself.

7. A path split method according to claim 2, wherein said LSR router which has built a SPT table checks whether the received CR-LDP message contains a RM message, if a RM message is contained, the LSR router will compare SPT table itself to the RM message, and then if they are completely same, the LSR router will decide to stop the CR-LDP message at the router, and conduct the path split based on the corresponding label information, and at the same time, add a path item into the MPLS transfer table.

8. A path split method according to claim 2, wherein said LSR router which has built a SPT table checks whether the received RSVP-TE message contains a RM message, if a RM message is contained, the LSR router will compare SPT table itself to the RM message, and then if they are completely same, the LSR router will decide to stop the RSVP-TE message at the router, and conduct the path split based on the corresponding label information, and at the same time, add a path item into the MPLS transfer table.

9. A path split method according to claim 1, the PM and RM messages contain band broadness information used in the band broadness control so as to guarantee the band broadness for real time communication when a mobile node performs a handover.

10. A path split method according to claim 2, wherein as receiving a PM message, each LSR router builds a Split Path Table (SPT) and adds an item into the table, in which all items are the same as the PM message.
